(19) United States
(12) Patent Application Publication
(10) Pub. No.: US 2021/0236867 A1
(43) Pub. Date: Aug. 5, 2021

(54) Method for Fire Protection and Suppression with Hydrogels and Compressed Air Foam Systems

(71) Applicant: Karen FLECKNER, Tacoma, WA (US)

(72) Inventor: Karen FLECKNER, Tacoma, WA (US)

(21) Appl. No.: 17/169,198

(22) Filed: Feb. 5, 2021

Related U.S. Application Data
(60) Provisional application No. 62/970,602, filed on Feb. 5, 2020.

(51) Int. Cl. A62C 35/64; A62C 99/00; A62D 1/02

(52) U.S. Cl. CPC A62C 35/64; A62D 1/0071; A62C 99/0072; A62C 99/0036

(57) ABSTRACT

A dispensing unit that consists of two or more dispensing solutions, at least one being a fluorine-free foam solution, and at least one hydrogel-based solution, and which involves the dispensing of each solution through one or more compressed air foam system (CAFS), where the CAFS may use compressed air, nitrogen, or other inert gas. The individual solutions may be mixed prior to the CAFS, or one or more solutions mixed after the CAFS, or they may be mixed in separate CAFS chambers. The resulting foam may be dispensed through a single line or through multiple lines, applied simultaneously and/or at different times, and may be controlled manually and/or through automatic controls, or through a combination of the above.

### CROSS-REFERENCE TO RELATED APPLICATIONS

This is a U.S. patent application which claims the priority to and benefit of U.S. provisional application No. 62/970,602, filed on Feb. 5, 2020, the disclosure of which is incorporated herein by reference in its entirety.

### BACKGROUND

The United States military selected aqueous film-forming foams (AFFF) in the 1960s as a fire suppressant to put out fuel fires (Class B fires). AFFF foams contain fluorocarbon and hydrocarbon surfactants that generate a foam when dispensed with water through an aspirating nozzle. The fluorocarbon surfactants reduce surface tension of the foam on the surface of the fuel due to the high electronegativity of the fluorine atoms. The reduced surface tension creates a thin film that rapidly spreads across the fuel, quickly distributing the foam across the fuel's surface. As a result, the film and foam layers help to suppress the fire by two primary mechanisms. One mechanism is by creating a vapor lock atop the fuel to prevent fuel vapors from escaping the foam layer, thus starving the flame of a fuel source. The second mechanism is by providing an insulating layer between the flame and the fuel, cooling the fuel, and reducing how much vapor is generated, further starving the fire.¹ An additional mechanism, not found in AFFF, for fire suppression is the disruption of the oxidative combustion reaction of the fuel by the introduction of chemical radicals.² ¹ R. Sheinson, et al., “The Future of Aqueous Film Forming Foam (AFFF): Performance Parameters And Requirements”, Naval Research Laboratory (2002).² W. Grosshandler, “Assessing Halon Alternatives for Aircraft Engine Nacelle Fire Suppression”, Journal of Heat Transfer, 117, p489 (1995).

The U.S. military developed the military specification (MILSPEC) MIL-F-24385F to certify commercial AFFF products to specific performance requirements prior to their use in military applications. One of the more stringent tests is its fire suppression performance, which requires that the AFFF must suppress a 10-gallon gasoline fire atop a 1″ substrate of water in a 28-sq.ft. pan at an application rate of 2 gallons per minute within 30 seconds at a 3% concentration of AFFF concentrate to water.¹

Since 2000, per- and poly-fluoroalkyl substances (PFAS), the class of chemicals that are used to make the fluorocarbon surfactants in AFFF as well as in other commodities like Teflon, have been identified as a potential human health hazard. PFAS are potentially toxic, can bioaccumulate in the body, and do not biodegrade in the environment.³ Evaluation of groundwater near military bases and industrial sites where AFFF had been used for fire suppression showed higher-than-acceptable levels of PFAS.⁴ The U.S. Government, as well as other world government organizations, have taken action to prohibit the use of PFAS, which restricts and bans the further use of AFFF, requiring replacements to be found for AFFF. Congress has banned the use of AFFF by the U.S. military by 2024, requiring a suitable replacement to be found. ³ B. Place and J. Field, “Identification of Novel Fluorochemicals in Aqueous Film Forming Foams (AFFF) Used by the US Military”, Environmental Science & Technology, 46, p7120 (2012).⁴ K. A. Barzen-Hanson, et al. “Discovery of 40 Classes of Per- and Polyfluoroalkyl Substances in Historical Aqueous Film-Forming Foams (AFFFs) and AFFF-Impacted Groundwater”, Environmental Science & Technology, 51, p2047 (2017).

One potential replacement to AFFF that has been identified are fluorine-free foams (FFF). These are typically synthetic hydrocarbon foams designed to approximate the same surface tension and electrostatic properties of fluorine-containing AFFF. The materials in FFF are also selected to avoid the environmental problems of AFFF foams. The lack of fluorine has demonstrated reduced physical and chemical stability in the presence of fuel vapors and high temperatures. FFF foams have been found to be less durable when applied to Class B fuels. The produced foams degrade at a much faster rate atop fuels, even at ambient conditions in the absence of heat or flame, compared to AFFF foams.^{5,6} No commercial FFF product have yet met the stringent standards for fire suppression for the MILSPEC for Class B fires with the best performing products taking more than 40 seconds to extinguish the MILSPEC 28 sq.ft. gasoline fire suppression test.⁷ ⁵ K. Hinnant, M. W. Conrow, R. Ananth, “Influence of fuel on foam degradation for fluorinated and fluorine-free Foams”, Colloids and Surfaces A: Physicochemical and Engineering Physics, 522, p1 (2017).⁶ T. Schafer, B. Dlugogorki, E. M. Kennedy, “Sealability Properties of Fluorine-Free Fire-Fighting Foams (FfreeF)”, Fire Technology, 44, p297 (2008).⁷ K. Hinnant, R. Ananth, J. P. Farley, C. L. Whitehurst, S. L. Giles, W. A. Maza, A. W. Snow, S. Karwoski, “Extinction Performance Summary of Commercial Fluorine-free Firefighting Foams over a 28 ft2 Pool Fire Detailed by MIL-PRF-24385”, Naval Research Laboratory, NRL/MR/6185-20-10,031 (2020).

In this invention, we consider two other approaches to modify FFF to improve fire suppression performance:
1) Hydrogels are a class of fire suppressant materials made from polymeric materials that are extremely hydrophilic and can carry up to 10×their weight in water. The hydrogel/water mixture has a “stay and stick” property allowing it to adhere to horizontal, vertical, and inverted surfaces for Class A fires, forming a thick protective layer that blocks flames and heat from reaching the surface. For Class B liquid fires, the hydrogel/water layer can stay atop the liquids, providing a vapor-lock to limit the release of vaporized fuel, and a cooling/heat-adsorbing layer that blocks the heat from the fire from reaching the fuel and quenches the fuel's temperature, reducing the volatility of the fuel. Both effects contribute to the suppression of the fire. Hydrogels can be used in most conventional fire-extinguishing equipment with little to no modification, only to account for their typical non-Newtonian nature. ^{8,9,10} ⁸ A. C. Smith, D. C. Fredley, D. Lauriski, E. D. Thimons, “Evaluation of a novel fire-blocking gel to prevent and suppress mine fires”, The National Institute for Occupational Safety and Health, January 2012.⁹ J. C. M. Bordado, J. F. P. Gomes, “New Technologies for Effective Forest Fire Fighting”, Intl. J. Env. Stud., 64(2), p243-251 (2007).¹⁰ CA 2,968,882, “Water-Enhancing, Fire-Suppressing Hydrogels” (2018).
Recent literature has shown that fluorine-free foams for fire suppression can be stabilized by the addition of polymer and hydrogel materials.^{11,12,13,14} This invention is applying these stabilizing materials to fluorine-free foam to increase stability and fire suppression characteristics to complement the mechanical advantage of CAFS. The effect of hydrogel addition can increase surface tension and viscosity of the foam mixture, which can lead to a more durable foam that can withstand the conditions of the fire, providing a better barrier against vapor release. However, the increased surface tension reduces the spreadability of the foam product across the surface of the fuel. An optimized mixture of foam, hydrogel, and additives can be selected to achieve increased spreadability and durability of the dispensed product, along with all other desired properties such as long-term material compatibility and shelf-life, ease-of-use, and environmental concerns. ¹¹ M. Uhlig, O. Lohmann, S. V. Ruiz, I. Varga, R. von Klitzing, R. A. Campbell, “New Structural Approach to Rationalize the Foam Film Stability of Oppositely Charged Polyelectrolyte/Surfactant Mixtures”, Chemical Communications, 56, p951 (2020).¹² A. Bureiko, A. Trybala, N. Kovalchuk, V. Starov, “Current Applications of Foams from Mixed Surfactant-Polymer Solutions”, Advances in Colloid and Interface Science (2014).¹³ E. Rio, W. Drenckhan, A. Salonen, D. Langevin, “Unusually Stable Liquid Foams”, Advances in Colloid and Interface Science (2013).¹⁴ Y. Sheng, N. Jiang, X. Sun, S. Lu, C. Li, “Experimental Study on Effect of Foam Stablizers on Aqueous Film-Foaming Foam”, Fire Technology, 54, p211 (2018).
2) Compressed Air Foam Systems (CAFS) use compressed air or other inert gas introduced into a foam/water mixture. The compressed air injects bubbles into the foam and activates the foam expansion properties while the foam concentrate is still in the dispensing equipment, rather than at the aspirating nozzle. This creates a more structured foam made from smaller bubbles, which can be controlled through pressure and flow rate adjustments. The expansion of the compressed gas also provides momentum energy to help push the foam/water through the equipment. This mechanical energy helps to compensate for the absence of the chemical energy of the electronegativity of fluorine through the formation of uniform, stable bubbles in the foam.¹⁵ ¹⁵ A. Kim, G. Crampton, J. P. Asselin, “A Comparison of the Fire Suppression Performance of Compressed-Air Foam and Foam-Water Sprinkler Systems for Class B. Hazards”, National Research Council Canada, IRC-RR-146 (January 2004).
Using typical nozzles, the foam/water/air mixture that leaves the CAFS equipment can be thrown far as a thick foam blanket that can be directed to cover and stick to vertical and inverted surfaces. Alternatively, the foam mixture can be dispensed through fixed misting or spray systems to fully cover an area. A CAFS system may achieve the strong foaming properties using less water than typical foam-based fire extinguishing equipment. There is data from many tests that shows CAFS possessing the right nozzle technology improves the bubble structure in the foam-making process demonstrating an increased performance in all foam concentrates tested.^{15,16} ¹⁶ D. Y. Feng, “Analysis on Influencing Factors of the Gas-liquid Mixing Effect of Compressed Air Foam Systems”, Procedia Engineering, 52, p105-111 (2013).

FFF fire suppression performance may be improved when FFF is combined with hydrogel through a CAFS system. The combined strengths of the protective coating and emulsifying characteristics of the hydrogel with a physical (mechanical) action of compressed air foam can bring many benefits enhance the vapor locking and cooling effects for fire suppression.

This invention identifies multiple pathways through which a CAFS-based system can incorporate both FFF and hydrogel concentrates for fire suppression. This includes the option of dispensing FFF and hydrogel through different CAFS dispensing streams to avoid potential compatibility issues while still gaining their shared benefit in fire suppression. This invention also considers the use of additives to improve compatibility between FFF and hydrogel as well as improving the vapor locking, cooling effect, and fire disrupting effect of the combined dispensed product.

### BRIEF DESCRIPTION OF THE INVENTION

The invention described is a fire suppression system that incorporates at least one CAFS system for dispensing at least one FFF concentrate and at least one hydrogel concentrate through either separate or common dispensing lines and nozzles. Additional concentrates of FFF, hydrogels or selected additives, may also be used. The FFF concentrate, hydrogel concentrate and any other concentrate may be pre-mixed in a single holding tank prior to the CAFS system, or the system may have multiple holding tanks for each concentrate to be added and mixed to the dispensing line through metering or proportioning equipment. The invention allows for a single dispensing stream consisting of the combined mixture of FFF, hydrogel, and other additives prior to, within, or following the CAFS unit, simultaneous dispensing through multiple dispensing lines of different combinations of the concentrations, or mixed dispensing options of each concentrate at different times. The system may be monitored and controlled through a control system for automated and remote operation, and tied to various management systems. The system may be tied to power system and may also include on-board water treatment systems.

### DETAILED DESCRIPTION OF THE INVENTION

In this invention, a CAF system (or CAFS) is defined to be a system that: 1) pumps water (either from on-board storage or an external source) through a fire pump, 2) adds a foam concentrate from a holding tank to the water through a metering or proportioning device (such as a proportioning pump or eductor system), 3) adds compressed air, nitrogen or other inert gas at pressures of at least 25 psig to cause the foam to bubble and expand within the dispensing system, either within the plumbing or within a mixing chamber, and 4) a dispensing line following the mixing chamber to direct the outlet flow of the CAF to a dispensing device such as a nozzle. Any CAFS configuration or design that dispenses foam and water with addition of compressed air, nitrogen, or other inert gas may be used in this invention. In a preferred embodiment, the compressed gas may include but is not limited to: air, nitrogen, an inert gas, or a combination thereof.

In the preferred embodiment, the CAFS system includes at least two fluid concentrates: a FFF concentrate and a hydrogel concentrate.

In this invention, any foam-based fire suppressant or extinguishing concentrate agent may be used in the CAF system, including film-forming forms, protein forms, and alcohol-resistant film-forming foam. These concentrates are typically water-based solutions with a mixture of surfactants and other compounds to stabilize the foaming agents.

In a preferred embodiment, the foam concentrate selected for the CAFS is fluorine-free. In a more preferred embodiment, the foam selected is environmentally benign and non-toxic to mammals and aquatic life.

In a preferred embodiment, the foam is a substance that has been certified as a qualified fire-fighting foam under one or more standards, which include but not limited to: U.S. Department of Defense (MILSPEC), the National Fire Protection Association (NFPA), Underwriters Laboratory (UL), the International Civil Aviation Organization (ICAO), EU Eco-Label, and other national, international, or industry-based standard for foams.

In this invention, the hydrogel concentrate is a solution consisting of a polymeric hydrocarbon along with other compounds to stabilize the hydrogel in solution. The solution may or may not be water-based depending on the selected hydrogel.

The material should be a hydrophilic compound that can absorb many times its weight in water. In the preferred embodiment, the hydrogel can include but are not limited to: the class of organic hydrogel materials containing but not limited to: polymers and polysaccharides, or from the class of inorganic polymers that include but not limited to: silica-based hydrogels, alumina-based hydrogels, silica-alumina-based hydrogels, and mixtures thereof, or mixtures of these classes.

In one embodiment, the hydrogel selected is an environmentally benign substance and non-toxic to mammals and aquatic life. In a more preferred embodiment, the hydrogel selected is 100% bio-based (originating from natural products rather than synthetic materials).

In one embodiment, the hydrogel product may be modified with additives and chemicals that do not affect the hydrogel's hydrophilic or fire suppression properties but to make it more compatible with the selected foam agent. In one preferred embodiment, these additives and chemicals may be added and mixed to the hydrogel concentrate (and possibly the FFF concentrate) prior to being loaded onto the CAFS system. In another preferred embodiment, the additives or chemicals may be loaded as a separate third fluid onto the CAFS system, and then metered into the hydrogel concentrate as required.

In a preferred embodiment, the hydrogel product may be modified with additives that fluorine-free surfactants or similar agents that provide or improve the hydrogel's expansion and spreadability to give it more foam-like properties, as to aid in the vapor locking effect in fire suppression. These surfactants can include but are not limited to hydrocarbons-based surfactants, alcohol ethoxylates and phosphate containing alcohol ethyloxylate surfactants, and their functional derivatives, and siloxane-based surfactants and their functional derivatives, including but not limited to siloxane, trisiloxane, organosilicane, and organosilicate nanostructured materials or a combination thereof.

In another preferred embodiment, the hydrogel product may be modified with additives to improve its compatibility with the selected foam as to increase the produced foam's durability and increase the cooling effect for fire suppression. Such additives may be used, for example, to prevent disruption of an anionic hydrogel by salt-based components that can be present in some foams.

These additives may include but are not limited to spreading agents, foam boosters, foam enhancers and stabilizers, hydrogen bonding reinforcement boosters, and foam solidifiers and thickening agents or a combination thereof.

In another preferred embodiment, the hydrogel product may be modified with additive that can suppress a fire through the generation of chemical radicals. These additives may include but are not limited to chlorinated or brominated hydrocarbons, or a combination thereof.

In another preferred embodiment, the hydrogel product may be modified with additive to improve the hydrogel's durability and performance. These additives may include but are not limited to: antioxidant agents, antimicrobial agents, antifungal agents, dispersing agents, suspending agents, emulsifiers, xantham Gum, hydroxyethylcellulose, and methyl-cellulose, or a combination thereof.

In another a preferred embodiment, the additive may be a combination of two or more of the classes of additives described above.

Within this invention, the hydrogel and FFF concentrates are combined through either an integrated system or an integrated process for improved fire suppression and fire prevention. There are three primary embodiments for how the hydrogel and FFF concentrates can be combined.

In the first primary embodiment, two separate systems, one to dispense FFF through a CAFS, and the second to dispense hydrogel by simple mixing with water (the “hydrogel system”), are utilized in an integrated process for fire suppression and fire protection. Both units would normally operate independently of each other. In a preferred embodiment, the two systems would be physically located at the same location (mounted next to each other for a fixed system or mounted on the same vehicle or pull cart) so that both are in proximity for a human operator.)

Within this first primary embodiment, as a preferred embodiment, the two units would be used simultaneously to cover the target area with a combined layer of hydrogel and CAFS-generated FFF over the same area.

In another preferred embodiment, the two units would be used simultaneously to cover one area with foam while covering another nearby area with hydrogel. Such a case may be used where the foam is being used to suppress a Class B fuel fire while the hydrogel is covering nearby flammable surfaces to prevent ignition and burnback from the fuel fire.

In yet another preferred embodiment, the CAFS unit would be used first to place down a CAFS-generated FFF layer and then the hydrogel unit would be used to cover that foam layer with a hydrogel layer.

In yet another preferred embodiment, the hydrogel unit would be used first to place down a hydrogel layer, and then the CAFS unit would be used to cover the hydrogel layer with a CAFS-generated FFF layer.

In yet another preferred embodiment, a phased application approach, alternating between CAFS-generated foam and hydrogel from the two systems would be used.

In yet another preferred embodiment, either the hydrogel or the CAFS system could be used in isolation of the other for specific fire-suppression or prevention needs. For example, in an area where there is no fire, but a fire hazard risk is nearby, the hydrogel system could be used alone to provide a protective coating within the area without using the foam system.

In a preferred embodiment, each system would have both manual and automatic controls with an interface to control the separate units independently of each other.

In an even more preferred embodiment, a managing control system would communicate to and from each of the individual units as to monitor tank levels, pressures, flow rates, temperatures, etc., and operational status of the unit, and to trigger automatic operation of each unit, in one of the manners expressed in the prior embodiment, such as switching between the application of hydrogel and CAFS-generated foam in repeated phases.

In a preferred embodiment, a common multi-head nozzle or spray component may optionally be used, with one nozzle or spray head connected to the hydrogel dispensing line and the second to the CAFS-generated foam dispensing line, allowing the operator to direct both hydrogel and CAFS-generated foam distribution to the same area for coverage.

In a more preferred embodiment, the multi-head nozzle includes appropriate flow rate adjustment controls to control the flow rate of hydrogel and CAFS-generated foam dispensing separately from the common endpoint.

In the second primary embodiment, the hydrogel and CAFS-generated foam would be dispensed through an integrated system containing two different dispensing lines, one for hydrogel and one for the CAFS-generated foam, though which would share other common equipment, such as power systems, water tank and fire pump. There would be separate lines for injection of the hydrogel and the foam into the water and subsequent delivery to separate hoses/nozzles or fixed spray systems. Separate dispensing systems (hoses and nozzles, sprinklers, sprayers, etc.) would be available to dispense the hydrogel and CAFS-generated foam from the separate mixing systems.

In a preferred embodiment, a common multi-head nozzle or spray component may optionally be used, with one nozzle or spray head connected to the hydrogel dispensing line and the second to the CAFS-generated foam dispensing line, allowing the operator to direct both hydrogel and CAFS-generated foam distribution to the same area for coverage. In a more preferred embodiment, the multi-head nozzle includes appropriate flow rate adjustment controls to control the flow rate of hydrogel and CAFS-generated foam dispensing separately from the common endpoint.

In a preferred embodiment, the side-by-side dispensing of CAFS-generated foam and hydrogel are performed simultaneously.

In another preferred embodiment, the side-by-side dispensing of CAFS-generated foam and hydrogel would occur in two or more stages. In one such embodiment, the CAFS-generated foam would be placed down first as to provide the rapid suppression that foams can provide. The hydrogel would then by applied to provide the cooling layer and burn-back protection it provides. In another such embodiment, the hydrogel layer is placed down first to provide the vapor-locking and cooling effects, followed by the CAFS-generated foam to provide additional vapor-locking control.

In additional more preferred embodiments, multiple application phases, switching between hydrogel and CAFS-generated foam appropriately. In such an application, the flow rate and proportioning of hydrogel and CAFS-generated foam may be adjusted between each phase of application.

In another preferred embodiment, the integrated system would be able to operate the hydrogel dispensing side, or the CAFS-generated foam dispensing system without operating the other. For example, in an area where there is no fire, but a fire hazard risk is nearby, the hydrogel system could be used alone to provide a protective coating within the area without using the foam system.

In a preferred embodiment, the side-by-side hydrogel/CAFS-generated foam system would have a singular set of integrated control system for monitoring and control of the common equipment and separate dispensing lines. This control system allows for separate adjustment of the flow rate and the proportioning of hydrogel and CAFS-generated into their respective system. In a more preferred embodiment, the control system would manage the operation of the hydrogel and CAFS-generated foam dispensing lines in one of the embodied processes described above.

In the third primary embodiment, the hydrogel is introduced within the CAFS directly and dispensed at the same time as the FFF, with the dispensing product being a mixture of foam, hydrogel, water, and air/nitrogen.

In a preferred embodiment, the hydrogel concentrate and foam concentrate are pre-mixed as a new concentrate that is then added to the water prior to the compressed air. The ratio of hydrogel and foam can be adjusted prior to mixing to achieve desired performance properties. This embodiment can be used when the hydrogel and foam concentrate show favorable long-term compatibility on the order of years.

In another preferred embodiment, the hydrogel concentrate is added separately from the foam concentrate into the water stream prior to the compressed air. System controls would allow for adjustment of the amount of hydrogel and foam concentrate to be added to the water. This type of scenario would be used if the long-term compatibility of hydrogel and foam is poor while the short-term compatibility (on the order of days to months). This scenario can also be used for long-term compatible hydrogel/foam concentrates as to provide direct control of amounts added.

In another preferred embodiment, the hydrogel concentrate is added following the compressed air addition to the foam/water mixture but prior to the outlet from the CAFS system. This approach may be needed if the hydrogel performance is disrupted by the addition of compressed air. System controls are used to adjust the amounts of hydrogel and foam concentrate to the CAFS. The location of the hydrogel addition following the compressed air addition would be determined based on the foaming/bubble performance in the dispensing piping. For example, if the main foaming/bubbling structure is determined to be complete 2 feet downstream from the compressed air injection, then the hydrogel may be introduced at a point 3 feet downstream from air injection, so that the hydrogel is not impacted by further foam formation. In CAFS that include a mixing chamber, the hydrogel may be injected within or downstream from the mixing chamber.

In this invention, the net ratio of hydrogel to foam concentrate by volume can from 1 part hydrogel to 1000 parts foam, up to 1000 parts hydrogel to 1 part foam, when both are used for fire suppression and prevention. More preferably, the ratio of hydrogel to foam is no greater than 1 to 1. This ratio would be measured based on the average consumption of hydrogel and foam concentrate over time, since preferred embodiments described above include scenarios where these concentrates would not be applied simultaneously.

In a preferred embodiment, the ratio of hydrogel to foam is adjustable using manual or automatic system controls that proportion the concentrates into the water stream(s).

In a preferred embodiment, the individual proportioning rates of hydrogel and foam concentrate, and thus the ratio of hydrogel to foam, may be adjusted during operation through the combined hydrogel/CAFS controls.

In a preferred embodiment, the combined hydrogel/CAFS system is powered directly from the local electrical grid, either through a permanent-wire connection or through a plug and outlet of appropriate voltage, current, and phase for the grid. The local grid may include power provided from the main utility operator serving the site, and/or from other sources including but not limited to: distributed energy resources such as natural gas turbines, standalone gas, diesel, or natural gas generators, renewable sources such as solar and wind power, fuel cells, battery storage, microgrid systems, and small module nuclear reactors (SMR).

In another preferred embodiment, the combined hydrogel/CAFS unit is powered from an on-board source, which can include but is not limited to batteries, gas or diesel engine, solar panels, fuel cells and SMRs.

In a more preferred embodiment, the combined unit has the capability to use both external power sources and on-board power sources.

In a yet more preferred embodiment, the combined unit automatically switches to its on-board power sources when its control system senses the loss of power from the external source. The sensing of the loss of power or potential loss of power may also be sent as a signal from the management software that the control system is in communication with.

In a preferred embodiment, the combined hydrogel/CAFS unit uses fresh utility water at the site. In another preferred embodiment, the combined unit includes on-board water storage.

In a more preferred embodiment, the combined unit can use both external water sources and on-board water storage.

In a yet more preferred embodiment, the combined unit automatically switches to its on-onboard water source when its control system senses the loss of water from the external. The sensing of the loss of water or potential loss of water may also be sent as a signal from the management software that the control system is in communication with.

In a more preferred embodiment, the combined unit may use non-fresh water sources which are known to be fully compatible with the hydrogel and foam concentrate and the hydrogel, CAFS, and combined hydrogel/CAFS system components. Such water sources may include but not limited to: brackish water, gray water, reclaimed water, rainwater, irrigation runoff, seawater, and wastewater.

In a more preferred embodiment, the combined unit may include a water treatment system to treat the non-fresh water source prior to mixing with the hydrogel or foam concentrate. The treatment system may include on or more treatment technologies, including but not limited to: filtration, reverse osmosis, forward osmosis, ion exchange, adsorption beds, and advanced oxidative treatment.

In an embodiment of this invention, the combined hydrogel/CAFS unit is operated through a computerized control system that monitors all on-board sensors and controls system elements including but not limited to: pumps and valves to control flow rate, concentration proportioning, water pressure, air pressure, and other operating factors. The organization of the control system would depend on the type of combined system—two separate systems, two integrated systems, or a single system—as described previously.

In a preferred embodiment, this control system includes an on-board user interface to allow the operator to monitor the system and make all changes to the operating settings. In an another preferred embodiment, the computerized control system included automatic process programs to manipulate the system controls as to follow prescribed extinguishing protocols, such as automating CAF distribution for a CAF layer followed by the hydrogel distribution for a hydrogel layer when either two separate or partially integrated distribution systems are used.

In a preferred embodiment, the computerized control system can communicate back and forth with one or more separate computer systems for remote monitoring and control of the combined hydrogel/CAFS unit.

In a more preferred embodiment, the type of connection between the control system on the combined hydrogel/CAFS unit and other computer system can include one or more but not limited to: wired (such as serial cable, USB cable, twisted pair cable, CAT5/Ethernet, and fiber optics), wireless (such as Wi-Fi, Bluetooth, WiMax, ZigBee), cellular (such as 4G and 5G networks and standards), satellite transmissions, and microwave, radio, infrared transmission, and SD-WAN.

In a yet more preferred embodiment, the connection between the control system and remote computer(s) would include cybersecurity protection, including but not limited to encryption.

In a more preferred embodiment, the remote computer systems that the control system communicates can include but not limited to: a desktop or laptop computer, a tablet computer, a mobile phone, a computer server, a database server, a cloud computing server or network, or edge computing devices or network.

In an even more preferred embodiment, the connection protocol between the control system on the combined hydrogel/CAFS system and the remote computer systems(s) includes one or more cybersecurity measures that include but not limited to: user authorization access, two-factor authorization, dongle/key-card authorization, communication firewalls, and virtual private networks (VPNs). These cybersecurity measures would be compliant with appropriate standards including but not limited to: NIST Cybersecurity Framework, and ISO/IEC 27001 and 27002.

In an even more preferred embodiment, when the control system communicates to edge computing devices, the control system itself is enabled with edge computing calculations to integrate with the edge computing network.

In a more preferred embodiment, the control system on the combined hydrogel/CAFS unit may be controlled remotely by a human operator using the separate computer system.

In another more preferred embodiment, the control system on the combined hydrogel/CAF unit may be controlled remotely by automated computer program located on the separate computer system(s).

In a yet more preferred embodiment, the automated computer program would be a standalone program or may be a component of a larger management software program that monitors a larger physical system that includes the combined hydrogel/CAFS unit, which can include but is not limited to: a building management system (BMS), a site management system, a plant operating/management system, an energy management system (EMS), a distributed energy resources management system (DERMS), or a C4ISR (Command, Control, Communications, Computers, Intelligence, Surveillance, and Reconnaissance) system.

In a yet more preferred embodiment, the communication between the combined unit and the management software program would be based on industrial standard protocols appropriate to the management software program which include but is not limited to: Smart Energy Profile 1.0, IEEE 2030.5/Smart Energy Profile 2.0, and Extensible Markup Language (XML).

In a yet more preferred embodiment, the larger physical system managed by the management software program includes one or more of the combined hydrogel/CAFS units in different locations or areas.

In a yet more preferred embodiment, the management software incorporates data related to fire risk and detection within the physical area that it is monitoring, including but not limited to: fire detectors, carbon dioxide detectors, temperature sensors, visible light and infrared cameras, weather data, GIS data, and other external data.

In a yet more preferred embodiment, the management software using software algorithms to determine the risk of fire hazard across the area it manages, which can include but not limited to: machine learning, artificial intelligences, neural networks, expert systems, genetic algorithms, Bayesian networks, Big Data analysis, edge compute analysis, quantum computing, and predictive simulations and models.

In a yet more preferred embodiment, the management software, on detecting either the presence or risk of fire, may either automatically engage the combined hydrogel/CAFS unit(s) in the affected area to suppress the fire or to protect the area before the fire can reach it, and/or may prepare the hydrogel/CAFS unit(s) to be used and connect human operators to perform the dispensing of the hydrogel and CAFS for fire suppression and prevention.

In a preferred embodiment, the control system on the combined hydrogel/CAFS unit reports its status to the remote computer, which can include but not limited to: stored levels of water, hydrogel and foam concentrate, availability of external water or power, remaining fuel or energy levels, equipment status, time-on-station, and system lifetime.

In a more preferred embodiment, either the control system on the combined hydrogel/CAFS unit or the software on the remote system alerts end users to potential system problems for deployment of maintenance and repair operations. These alerts can include but not limited to: low water levels, low hydrogel or foam concentrate levels, lack of or limited availability of external water or power sources, out-of-spec conditions of system components that may indicate repairs are needed, out-of-spec temperature or pressure within the dispensing line(s) that may indicate blockage, or time-on-station alerts where requirement maintenance on system components is required.

In another more preferred embodiment, the data sent from the control system of the hydrogel/CAFS system to the remote computer is used as part of a resource management system (RMS) to track the uses of hydrogel and foam from supply sources to maintain sustainability of supply of these concentrates.

In an embodiment of this invention, the combined hydrogel/CAFS unit is used for fire suppression and extinguishing of Class A (flammable solids), Class B (flammable liquid), Class C (energized electrical equipment), and Class D (combustible metal) fires. In another embodiment, the combined hydrogel/CAFS unit is used to provide fire protection to the area it serves when there is a threat of a nearby fire to spread into the area, or when there is potential threat of a fire outbreak (such as after an accidental break in a natural gas line).

In a preferred embodiment, the combined hydrogel/CAFS unit is used to reduce risk of fire of the site where it is located. In this embodiment, the control system on the combined hydrogel/CAFS unit(s) would be in communication with a management software program that monitors a local area. On detection of a fire hazard or identification of a high fire risk, the management software can either automatically engage the combined hydrogel/CAFS system or alert operators to engage the system to quickly suppress and extinguish the fire hazard, or to protect the area near the hydrogel/CAFS system before the fire risk becomes a real fire.

In one embodiment, the CAFS unit is fixed in place, and may either deliver CAF through dispensing hoses or through a fixed system, such as through overhead sprinklers, surface-mounted nozzles, or other similar devices.

In another embodiment, the CAFS unit is a portable system—either vehicle-mounted or moved directly by a human operator—and uses nozzles and hoses to dispense the CAF.

In yet another preferred embodiment, the combined hydrogel/CAFS unit is installed as a deployable system. In this approach, the unit may remain in one assigned location for most of its time, but during emergency operations, the unit can be deployed to a remote location where it is needed, and then returning the unit to its assigned site afterwards.

In yet more preferred embodiment, when the combined hydrogel/CAFS unit(s) are connected via control system and communications to a larger management system which monitors a larger area, the management system may alert operators to prepare and move the combined hydrogel/CAFS unit(s) to specific locations ahead of a specific fire hazard that has been detected or where there is a high risk of fire as determined by the management software. This would be a further reduction of risk to the area monitored by the management software with the expeditionary aspects of the combined unit.

In a preferred embodiment of this invention, the combined hydrogel/CAFS unit is used for fire suppression and protection in the markets of, but not limited to, military, municipal fire-fighting departments, forest/land fire-fighting departments, governmental institutions, academic institutions including universities and schools, commercial aviation, oil & gas production, chemical production, other industrial sites, commercial buildings including retail and office, residential/domestics, marine, and terrestrial space development.

In yet another preferred embodiment of this invention, the combined hydrogel/CAFS unit is used as a general purpose automatic or on-response system for cleaning, sanitation, sterilization, and decontamination of public areas using chemical foams and hydrogels that are suitable for combating chemical, biological, bacterial, viral, nuclear, and radioactive hazards. The foam(s) and hydrogel(s) selected for the application would have appropriate target activity towards the target hazard(s), and account for toxicity concerns for those that would use the area and local environment after their application, and chemical compatibility. These systems can be installed throughout public spaces, within high-use private areas, or in an open area, using a combination of spray, misting or aerosol spray systems to deliver the cleaning foam and hydrogel products to the exposed surfaces in a controlled fashion, following by additional rinsing cycles if needed. The actions of foam and hydrogel application should neutralize and remove hazards from the area after completion. These systems can be automated to run during off-hours when people are not present, or manually activated in the case of an emergency. Alternatively, portable systems can be used to bring these cleaning foams/hydrogels to areas that need cleaning and sterilization for an as-needed solution. In a yet more preferred embodiment, such cleaning and sterilization systems are installed and operated in parallel with the hydrogel/CAFS systems used for fire suppress, utilizing the same equipment, such as power supplies, water supply, and control system, where possible.

1. A dispensing system for two or more fluid solutions, wherein at least one fluid solution includes a fluorine-free foaming (FFF) concentrate (a solution containing at least one FFF compound), and where at least one other fluid solution includes a hydrogel concentrate (a solution containing at least one hydrogel compound), and wherein the system comprises:
at least one water pump,
at least one holding tank,
at least one metering system,
at least one compressed air foam system (CAFS) system, wherein the CAFS comprises:
a source of compressed gas, the source which can include a bottled/cylinder gas, a gas compressor, or a combination of these; and where the gas can include but is not limited to air, nitrogen, inert gas, or a combination thereof, and,
a mixing chamber for a fluid solution with water and the compressed gas;
at least one dispensing line,
at least one dispensing device,
sensors and controls to monitor and regulate flows, and
a control system to collect data from the sensors and activate controls and other dispensing system devices.

2. The dispensing system of claim 1, where the CAFS compresses gas is nominally delivered as a pressure greater than 25 psig and up to 1,400 psig.

3. The dispensing system of claim 1, where the FFF concentrate includes but is not limited to: hydrocarbon-based surfactants, alcohol ethoxylates and phosphate containing alcohol ethyloxylate surfactants and their functional derivatives, and siloxane-based surfactants and their functional derivatives, including but not limited to siloxane, trisiloxane, organosilicane, and organosilicate nanostructured materials, or a combination thereof.

4. The dispensing system of claim 1, where the hydrogel concentrate which may include but are not limited to hydrocarbon hydrogel including but not limited to:
organic hydrogels including but not limited to: polymers and polysaccharides;
inorganic hydrogels including but not limited to: silica-based hydrogels, alumina-based hydrogel, silica-alumina-oxide based hydrogels;
or a combination thereof.

5. The dispensing system of clam 1, where the ratio of hydrogel concentrate to FFF concentrate is greater than 1:1000 but less than 1000:1 based on volume as determined by average consumed volume over time from the dispensing system, and more preferable less than 1:1.

6. The dispensing system of claim 1, where a third fluid solution on the system is an additive that includes but is not limited to:
hydrocarbons-based surfactants and their functional derivatives;
siloxane-based surfactants and their functional derivatives, including but not limited to siloxane, trisiloxane, organosilicane, and organosilicate nanostructured materials;
other additives including but not limited to: spreading agents, foam boosters, foam enhancers and stabilizers, hydrogen bonding reinforcement boosters, and foam solidifiers and thickening agents, chlorinated or brominated hydrocarbons, antioxidant agent, antimicrobial agent, antifungal agent, dispersing agents, suspending agents, emulsifiers, xantham gum, hydroxyethylcellulose, and methyl-cellulose; or a combination thereof.

7. The dispensing system of claim 6, where the ratio of the additive third fluid solution mixed with the hydrogel concentrate is greater than 1:100,000 but less than 1:1 based on volume as determined by average consumed volume over time from the dispensing system.

8. The dispensing system of claim 6, where the additive third fluid solution is mixed with the hydrogel concentrate prior to loading into a holding tank onto the system.

9. The dispensing system of claim 6, where the additive third fluid solution is metered into the system distribution lines to be mixed with the hydrogel concentrate within the system.

10. The dispensing system of claim 1, where the FFF concentrate is metered into the pumped water line and made into a foam through a CAFS unit as one dispensing stream, and where the hydrogel concentrate is metered into a second pumped water line and prepared as a second dispending stream.

11. The dispensing system of claim 10, where the CAFS FFF dispensing stream and the non-CAFS hydrogel dispensing stream would be dispensed through separate dispensing lines and dispensing devices.

12. The dispensing system of claim 10, where the CAFS FFF dispensing stream and the non-CAFS hydrogel dispensing stream would be dispensed through separate dispensing lines sharing a common dispensing device.

13. The dispensing system of claim 10, where the separate dispensing streams may be operated simultaneously or by alternating between the different dispensing streams, or a combination thereof.

14. The dispensing system of claim 1, where the FFF concentrate is metered into the pumped water line and made into a foam through a CAFS unit, and where the hydrogel concentrate is metered into the CAFS stream either prior, at, or after the CAFS unit, resulting in a single foam dispensing line a common dispensing device.

15. The dispensing system of claim 14, where the separate dispensing streams may be operated simultaneously or by alternating between the different dispensing streams, or a combination thereof.

16. The dispensing system of claim 1, where the FFF concentration and the hydrogel concentrate are mixed prior to filling to the holding tank, and the mixture is metered into the pumped water line, made into a foam through a CAFS unit as a single dispensing stream through a dispensing device.

17. The dispensing system of claim 1, where the dispensing device includes but not limited to a non-aspirating nozzle, an aspirating nozzle, vehicle-mounted nozzles, overhead dispensing systems, and sprinkler devices, or a combination thereof.

18. The dispensing system of claim 1, where the dispensing system monitors variables including but not limited to: concentrate flow rates, foam production rates, dispensing rates, compressed gas pressures, dispensing pressures, storage temperatures, foam temperature, dispensing temperatures, storage levels in holding tanks, storage levels in compressed gas storage, and ambient and air temperature, pressure, humidity, or a combination thereof.

19. The dispensing system of claim 1, where the dispensing system's control system can be used to adjust operating parameters including but not limited to: metering ratios for FFF, hydrogel and other fluids, pumped water flow rate, pumped water pressure, compressed gas pressure, compressed gas flow rate, CAFS system pressure, dispensing pressure, dispensing flow rate, valve operation for switching between dispensing lines, or a combination thereof.

20. The dispensing system of claim 1, where the dispensing system's control systems include communication devices for manual and automatic control through remote monitoring using communication protocols:
where the communication protocols may include security, encryption, and cybersecurity standards, including but not limited to: user authorization access, two-factor authorization, dongle/key-card authorization, communication firewalls, and virtual private networks (VPNs), NIST Cybersecurity Framework, or ISO/IEC 27001 and 27002, or a combination thereof;
with communication protocols including but not limited to: wired (such as serial cable, USB cable, twisted pair cable, CAT5/Ethernet, and fiber optics), wireless (such as Wi-Fi, Bluetooth, WiMax, ZigBee), cellular (such as 4G and 5G networks and standards), satellite transmissions, and microwave, radio, infrared transmission, or SD-WAN, or a combination thereof.

21. The dispensing system of claim 20, where the dispensing system's control system may be remotely controlled through a computing device including but not limited to: a desktop or laptop computer, a tablet computer, a mobile phone, a computer server, a database server, a cloud computing server or network, or edge computing devices or network, or a combination thereof.

22. The dispensing system of claim 20, where the control system is connected to one or more external software management systems, including but not limited to: building management system (BMS), a site management system, a plant operating/management system, an energy management system (EMS), a distributed energy resources management system (DERMS), or a C4ISR (Command, Control, Communications, Computers, Intelligence, Surveillance, and Reconnaissance) system, or a combination thereof.

23. The dispensing system of claim 22, where the management system is further tied to devices and systems that monitor for fire risk and detection, including but not limited to: fire detectors, carbon dioxide detectors, temperature sensors, visible light and infrared cameras, weather data, GIS data, other external data, or a combination thereof.

24. The dispensing system of claim 23, where the management software using software algorithms to determine the risk of fire hazard across the area it manages with data from the fire risk and detection devices, which can include but not limited to: machine learning, artificial intelligences, neural networks, expert systems, genetic algorithms, Bayesian networks, Big Data analysis, edge compute analysis, quantum computing, and predictive simulations and models, or a combination thereof.

25. The dispensing system of claim 22, where the dispensing system's control system reports to a management system its operation and performance variables related to the dispensing system performance, including but not limited to: stored levels of water, hydrogel and foam concentrate, availability of external water or power, remaining fuel or energy levels, equipment status, time-on-station, and system lifetime, low water levels, low hydrogel or foam concentrate levels, lack of or limited availability of external water or power sources, out-of-spec conditions of system components that may indicate repairs are needed, out-of-spec temperature or pressure within the dispensing line(s) that may indicate blockage, or time-on-station alerts, or a combination thereof.

26. The dispensing system of claim 20, where the dispensing system's control system is connected to a resource management system (RMS) to track the dispensing systems resource availability including but not limited to: FFF concentrate availability, hydrogel concentrate available, water availability, power availability, or a combination thereof.

27. The dispensing system of claim 1, where the dispensing system is powered either directly from the utility grid, or from local sources including but not limited to: distributed energy resources such as natural gas turbines, standalone gas, diesel, or natural gas generators, renewable sources such as solar and wind power, fuel cells, battery storage, microgrid systems, and small module nuclear reactors (SMR), or from a combination of both utility grid and local sources.

28. The dispensing system of claim 1, where the dispensing system may use water from a source including but not limited to: a utility/municipal water source; natural and man-made water sources; an external water system, including but not limited reverse osmosis systems, filtration systems, distillation systems, processed water from co-located facilities, waste-water treatment plants, geothermal water, atmospheric water generations, or a combination thereof; an on-board water generation unit; or a combination thereof.

29. The dispensing system of claim 1, where the dispensing system incorporates a water treatment system that includes one or more of the following technology, not limited to: filtration, reverse osmosis, forward osmosis, ion exchange, adsorption beds, and advanced oxidative treatment, or a combination thereof.

30. The dispensing system of claim 29, where the dispensing system may use a water source that includes but is not limited to: brackish water, gray water, reclaimed water, rainwater, irrigation runoff, seawater, and wastewater, or a combination thereof.

31. The dispensing system of claim 1, where the dispensing system is used for combating Class A (flammable solid), Class B (flammable liquids and gas), Class C (energize electric equipment), or Class D (combustible metals) fire.

32. The dispensing system of claim 1, where the dispensing system may be fixed in place, may be transportable or portable, or may be used as a deployable or expeditionary system, or a combination thereof.

33. The dispensing system of claim 1, where the dispensing system is used in the markets for but not limited to: military, municipal fire-fighting departments, forest/land fire-fighting departments, governmental institutions, academic institutions including universities and schools, commercial aviation, oil & gas production, chemical production, other industrial sites, commercial buildings including retail and office, residential/domestics, marine, and terrestrial space development.

34. The dispensing system of claim 1, where the FFF concentrate and hydrogel concentrate are replaced with other foam and chemical concentrates, respectively, to produce a CAFS foaming system to be used for the cleaning, sanitation, sterilization, and decontamination of areas affected by chemical, biological, bacterial, viral, nuclear, and radioactive hazards.

35. The dispensing system of claim 1, where the dispensing system and its auxiliary systems including control system (as per claim 20), connected management system(s) (as per claim 22), power system (as per claim 27) and water system (as per claim 30) are autonomously controlled and may be connected to federal, state, municipal government emergency systems for emergency response.

36. The dispensing system of claim 1, where the dispensing system incorporates at least one other fire suppression systems, including but not limited to: water misting systems, dry chemical agent systems, carbon dioxide fire suppressors, ultra-high pressure fire suppression systems, or a combination thereof.
